(19) United States
(12) Patent Application Publication
(10) Pub. No.: US 2012/0002792 A1
(43) Pub. Date: Jan. 5, 2012

(54) Wireless intercom emergency assistance system

(76) Inventor: Michael Chang, Taipei City (TW)

(21) Appl. No.: 12/927,138

(22) Filed: Nov. 9, 2010

Related U.S. Application Data
(60) Provisional application No. 61/335,978, filed on Jan. 14, 2010.

(51) Int. Cl. H04M 11/04

(52) U.S. Cl. 379/40

(57) ABSTRACT

A wireless remote intercom emergency assistance system having a pendent transceiver designed to send signal through a telephone dialing device to a monitoring station for the operator to engage two-way voice communication between pendent transceiver device user and monitoring station, the system comprises:
an RF transceiver which transmits a first signal in response to manual action performed on the wireless pendant by the user, the telephone dialing device receives the first transmitted signal and transmits a second coded signal to a monitoring station,
the monitoring station computer is disposed to receive the telephone dialing device generated second signal, and transmit's a third signal to the identified telephone dialing device; the identified telephone dialing device receives the third signal and responsively transmits a fourth signal to the remote pendent transceiver device to open two-way voice communication between the pendent transceiver user and the monitoring station personnel for assistance.

### BACKGROUND OF THE INVENTION

In the past, different methods and wireless pendent devices have been used to provide emergency assistance for elderly or for individuals having medical conditions. Although some of those prior art teachings are found to be useful, in general most of the prior arts utilized different methods to notify a monitoring station personnel and establish two way voice conversation between the person in need of emergency assistance and a monitoring station operator. The teachings found in prior arts are not able to provide adequate methods to secure the positive operation of emergency assistance equipment, in particularly teachings found in prior arts fail to provide fully supervised emergency assistance system, which ascertains supervisory operation of the system in accordance with the embodiment of the invention.

However certain prior art teachings found to be useful and contains some of the teachings found in present art it is clear none of the prior art teachings have or present supervisory and positive operational improvement of the present art.

One such example U.S. Pat. No. 5,521,582 to Kingston An alarm system which includes an alarm signaling device comprising a housing adapted to be worn on the person, the alarm signaling device including: transmitter means for sending out radio signals, a microphone for picking up sounds and producing audio signals to modulate said transmitter means, emergency trigger means for operating the transmitter means, and code generator means for modulating the transmitter means with an encoded identification signal, said transmitter means, said microphone, said trigger means and said code generator means being operatively interconnected, and said transmitter means being constructed to transmit, for an initial period, encoded information from said code generator means, and to thereafter switch automatically to transmit said audio signals for a second period.

Kingston teaching includes control means which comprises radio receiver means and a recognition circuit for initiating a telephone call to a remote location via a telephone system when the correct encoded identification signal is received the control means being arranged to feed said audio signals to the remote location via the telephone system.

Unfortunately Kingston teaches a one way user voice transmission from a pendent unit to monitoring station via home panel, the signal sent to monitoring station does not contain Digital data, therefore Kinston teaching can only serve to notify a person whom possesses a telephone receiver device, such as a neighbor, a relative or a 911 operator whom can receive a verbal assistance request, since Kinston method does not provide event digital report, a recipient of the emergency call has no means to log electronically the event in the monitoring company system.

U.S. Pat. No. 7,526,269 to Mr. Walker III which teaches a wireless remote intercom system for a facility, the system comprising a wireless pendant transmitting a first signal in response to manual action performed on the wireless pendant by a user; a telephone dialing device having a device location; a central computer containing a list of all telephone dialing devices within the facility, the central computer disposed to receive the first signal, select a telephone dialing device from the list, and transmit a second signal to the selected telephone dialing device; the selected telephone dialing device receiving the second signal and responsively dialing a telephone number of a remote party, the telephone dialing device further supporting two-way communications between the user and the remote party. Unfortunately Walker III teaching does not use two way voice pendant, the operator opens two way voice on user home panel which is located on a desk or wall, therefore user can not carry the emergency assistance calling device in and around a facility as a portable device.

U.S. Pat. No. 7,315,736 Jenkins which teaches a personal emergency response communications system, comprising: a portable communications unit intended to be carried by a user who may require emergency attention, including (1) a wireless transmitter and a wireless receiver for respectively transmitting and receiving communication signals, (2) a call button actable by the user to initiate a call request signal that will result in placing the user in voice communication with an emergency response provider; a base communications unit coupled with a dial-up telephone system for establishing voice communication between the user and the emergency response provider, the base unit including (1) a wireless transmitter and a wireless receiver for respectively transmitting and receiving communication signals, and (2) a dialer for dialing the emergency response provider telephone number, a memory for storing a telephone number of the emergency response provider in one of the portable communications unit and the base communications unit, and a controller responsive to the call request signal for controlling the dialer to dial the emergency response provider telephone number,

wherein the memory stores electrical signals convertible into pre-selected voice messages, a speech synthesizer is provided for reproducing the pre-selected voice messages from the stored signals indicative of the status of the call request, and the controller is operative to deliver the pre-selected voice messages to the portable unit, and wherein the pre-selected voice messages include a first voice message indicating that the emergency response provider number is being dialed, and a second voice message indicating that the call to the provider is being terminated.

U.S. Pat. No. 7,231,200 Jenkins teaches a personal emergency response communications system comprising: a portable communications unit intended to be carried by a user who may require emergency attention, including: (1) a wireless transmitter and a wireless receiver for respectively transmitting and receiving communication signals, (2) a call button actable by the user to initiate a call request signal that will result in placing the user in voice communication with an emergency response center; and a base communications unit coupled with a dial-up telephone system for establishing voice communication between the user and the emergency response center, the base unit including (3) a wireless transmitter and a wireless receiver for respectively transmitting and receiving communication signals, (4) a memory for storing a telephone number of the emergency response center, (5) a dialer for dialing the emergency response center telephone number, (6) a controller responsive to the call request signal for controlling the dialer to dial the emergency response center telephone number, wherein the base unit includes a speech synthesizer for producing pre-selected voice messages indicative of the status of the call request, and the controller is operative to deliver the pre-selected voice messages to the portable unit; and wherein the pre-selected voice messages include a first voice message indicating that the emergency response center number is being dialed, and a second voice message indicating that the call to the center is being terminated.

Nevertheless the teachings in U.S. Pat. No. 7,315,736 and U.S. Pat. No. 7,231,200 Jenkins, found to be useful and contains some of the teachings found in present art; Again it is clear none of prior art teachings have or present supervisory and positive operational improvement of the present art.

Further the teaching found in the present invention represents definite improvement to the art by utilizing a method wherein the wireless pendent user assistance call can only be received by a supervised monitoring station equipped with a digital receiver and a PC, its operator based on received Digital data identifies the incoming assistance call and accordingly establishes two way voice communication with the person in need of assistance, thus the present art teaching provides monitoring stations with the ability to provide event time stamp if needed, and accordingly charges monthly monitoring fee to its clientele, contrary to some of the prior art teachings wherein the wireless pendent user calls can be received by any party whom possesses an ordinary telephone able to respond to the emergency call, which then eliminates the need of a monitoring station service thus the system cannot provide any supervised event record to authorities if needed, and prior art teaching eliminates monitoring stations generating service revenues.

The present invention is designed to send digital data to monitoring station and accordingly certified monitoring station operator opens two way voice conversation between the operator and the person in need of assistance which is a definite improvement to the art, such that the user by pressing the pendent button sends a first RF signal to trigger the home telephone dialer panel to initiate a call and once the monitoring station receives the emergency signal, the monitoring station operator Identifies the incoming caller ID and accordingly sends a command signal to the user home panel, and the panel upon receipt of the signal transmits an RF signal to engage user carryon voice pendent unit into two way voice mode for monitoring station operator to speak with the person in need of assistance.

Therefore it is a primary objective of the present invention to utilize a wireless two way voice pendant transceiver device worn by the user, used for providing emergency assistance by establishing a wireless communication with a telephone dialing device located within a facility used for signaling a monitoring station for the operator to call back and/or place a command to establish a supervisory two-way voice communication with the wireless pendent transceiver device through the telephone dialing device.

It is another objective of the present invention which provides a wireless RF pendent emergency call assistance device having a pendent device processor and containing a supervisory RF signal strength measurement circuitry designed to measure RF communication signal strength between said pendent device and said telephone dialer device, wherein said pendent device in response to supervisory RF signal loss generates audio, visual, and/or vibrating alarm signal to alert the user going out of RF communication proximity range of the telephone dialer device.

It is another objective of the present invention which utilizes a telephone dialing device which in response to detected RF communication loss with an RF pendent device, the telephone dialing device will transmit a signal to a monitoring station containing information of signal loss condition so the monitoring station may determine person to be monitored carrying the pendent device has left the predetermined facility proximity.

It is further objective of the present invention is to provide a wireless remote intercom emergency assistance system using a pendent device processor and containing a supervisory low battery detection circuitry, the pendent device in response to low battery signal detection generates audio, visual and/or vibration alarm signal to alert the user of low battery condition, and/or transmits the low battery detection condition to a monitoring station through the phone dialing device.

### SUMMARY OF THE INVENTION

A wireless remote intercom emergency assistance system used in a facility, the system utilizes a wireless pendant transceiver designed to communicate with a telephone dialing device which is designed to signal a monitoring station for the operator to call back and/or place a command to establish two-way voice communication or Push-to-Talk with the wireless pendent transceiver device through the telephone dialing device, which comprises:

A RF transceiver which transmits a first signal in response to manual action performed on the wireless pendant by a user; a telephone dialing device which has a device location within proximity of pendent device, receives the first transmitted signal and transmits a second signal to a monitoring station containing information of the telephone dialing device.

A monitoring station computer containing a list of all telephone dialing devices information within the monitoring facilities, the central monitoring computer is disposed to receive the telephone dialing device generated second signal, to identify the telephone dialing device from the list, and to transmit a third signal to the identified telephone dialing device; the identified telephone dialing device receives the third signal and the telephone dialing device responsively transmits a fourth signal to the remote pendent transceiver device, the pendent transceiver upon receipt of the fourth signal from the telephone dialing device establishes a two-way voice communication through the telephone dialing device between the user of pendent wireless device and the central monitoring station personnel which then provides assistance to the wireless pendent user.

The teaching found in the present invention represents improvement to the art by utilizing a method wherein the wireless pendent user assistance call can only be received by a supervised monitoring station operator whom accordingly establishes two way voice communication with the person in need of assistance, thus the present art teaching provides monitoring stations the ability to charge monthly monitoring fee to its clientele, contrary to prior art teachings wherein the wireless pendent user calls can be received by any party whom possesses an ordinary telephone able to respond to the emergency call, which then eliminates the need of a monitoring station service, causing monitoring stations to loose monthly generated service revenues.

### DESCRIPTION OF THE DRAWINGS

FIG. 1 Describes an emergency pendant device carried by the user, designed for establishing wireless digital data and two way voice communication with telephone dialer control panel.

And a telephone dialer device located in a facility within RF proximity range of pendent device, designed to communicate with wireless pendent device, and establish digital data and two way voice communication with a monitoring station. And a central monitoring station having a monitoring personnel equipped with Digital receiver and a computer used to establish digital data and two way voice communication with user person pendent unit through the telephone dialer device.

FIG. 2 Is the Block Diagram of the present invention.

### DETAILED DESCRIPTION OF THE PREFERRED EMBODIMENT

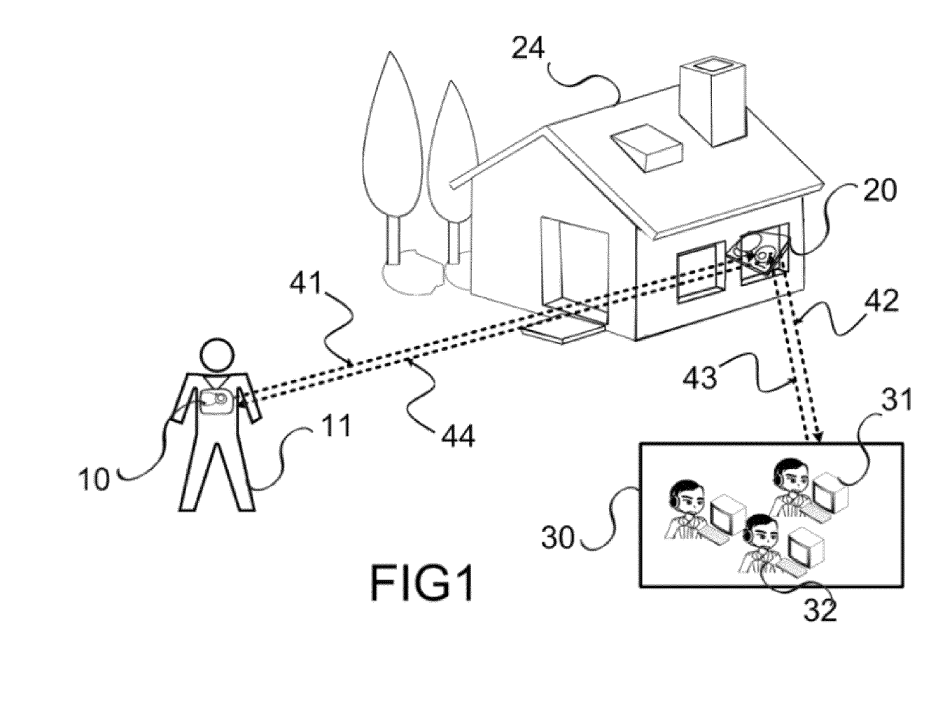

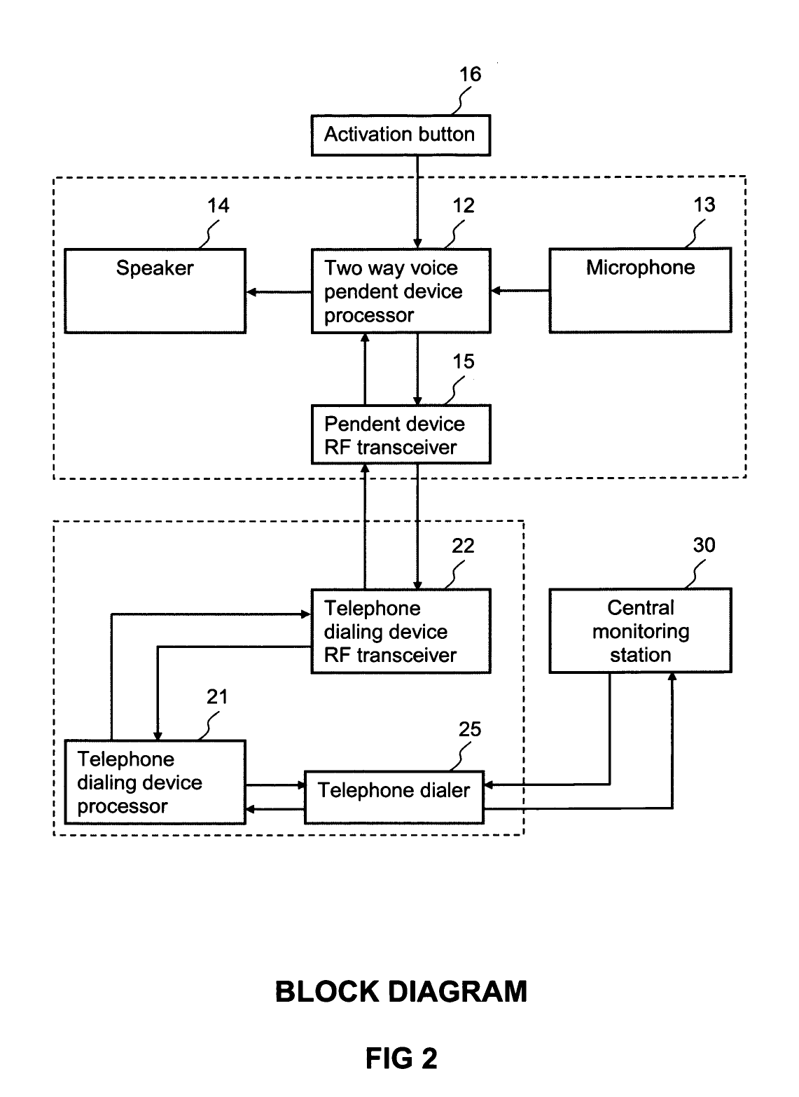

Referring to FIG. 1 and FIG. 2, a wireless remote intercom emergency assistance system is disclosed in this specification. The system used in a facility 24 includes an emergency pendant device 10, a telephone dialing device 20, and a central monitoring station 30:

1. The emergency pendant device 10 is carried by a user 11 and has:
(1) A pendant device electronic circuitry,
(2) A processor 12 to control the operation of the pendant device circuitry,
(3) A battery to supply power to the pendant device circuitry,
(4) A RF wireless transceiver 15 designed to establish RF communication with the telephone dialing device 20,
(5) A button 16 used for activating the pendant RF wireless transceiver 15 to communicate with the telephone dialing device 20, and
(6) A microphone 13 and a speaker 14 used for audio communication.

The pendant device 10 is designed for establishing wireless digital data and two way voice communication with the telephone dialing device 20.

2. The telephone dialing device 20 is located in the facility 24 within RF proximity range of the pendant device 10 which comprises of:
(1) A processor 21,
(2) A telephone dialer 25, and
(3) A wireless RF transceiver 22 designed to establish RF communication with the wireless pendant device 10, as well as to establish digital data and two way voice communication with the central monitoring station 30 operator 32.

The telephone dialing device 20 is designed to signal the monitoring station 30 for the operator 32 to call back and/or place a command to establish two-way voice communication with the wireless pendant transceiver device 10 through the telephone dialing device 20.

3. The central monitoring station 30 has:
(1) A digital receiver, and
(2) A monitoring station computer 31 used to establish digital data and two way voice communication with the pendant device 10 through the telephone dialing device 20. The monitoring station computer 31 contains a list of the information of the telephone dialing devices 20.

In a preferred embodiment of the invention:

1. When the user 11 needs emergency assistance, the user 11 presses the button 16 of the neck or wrist pendant device 10.
2. The pendant device 10 processor 12 activates the pendant transceiver 15 to transmit a first signal 41 to the telephone dialing device 20 RF transceiver 22.
3. The telephone dialing device 20 processor 21 upon receipt of the first signal 41 sends a signal for the telephone dialer 25 to dial the monitoring station 30 telephone number and to transmit a second signal 42 to the monitoring station computer 31.
4. After the monitoring station computer 31 identifies the telephone dialing device 20 from the list, the monitoring station 30 operator 32 sends a handshake signal through the digital receiver to the identified telephone dialing device 20 processor 21.
5. The telephone dialing device 20 processor 21 sends a contact ID code to report an emergency event to the monitoring station 30 computer 31.
6. The monitoring station 30 operator 32 sends a kiss-off signal to the telephone dialing device 20 processor 21.
7. The telephone dialing device 20 processor 21 sends a contact ID code (example 606) of Follow-On to wait commands from the monitoring station 30 operator 32.
8. The operator 32 makes the central monitoring station computer 31 transmit a third signal 43 to the identified telephone dialing device 20 to remotely control the telephone dialing device 20. The third signal 43 can be the following DTMF commands:
Enter DTMF tone (2) to open TWO-WAY VOICE COMMUNICATION with the user 11 of the pendant device 10 through the telephone dialing device 20.
Enter DTMF tone (1) to TALK to the user 11 of the pendant device 10 ONLY.
Enter DTMF tone (3) to LISTEN-IN to the user 11 of the pendant device 10 ONLY.
   9. After the identified telephone dialing device 20 receives the third signal 43, the telephone dialing device RF transceiver 22 responsively transmits a fourth signal_44 to the pendent device RF transceiver 15.
   10.
   a) If the third signal 43 is the DTMF command (2):

The pendant transceiver 15 upon receipt of the fourth signal 44 from the telephone dialing device 20 establishes a two-way voice communication through the telephone dialing device 20 between the user 11 and the monitoring station operator 32 for the operator 32 to provide needed assistance for the wireless pendant user 11.

b) If the third signal 43 is the DTMF command (1):

The pendant transceiver 15 upon receipt of the fourth signal 44 from the telephone dialing device 20 enables the operator 32 to talk to the user 11 only through the telephone dialing device 20 for the operator 32 to provide needed assistance for the wireless pendant user 11.

c) If the third signal 43 is the DTMF command (3):

The pendant transceiver 15 upon receipt of the fourth signal 44 from the telephone dialing device 20 enables the operator 32 to listen-in to the user 11 only through the telephone dialing device 20 for the operator 32 to provide needed assistance for the wireless pendant user 11.

In another embodiment of the invention:

1. When the user 11 needs emergency assistance, the user 11 presses the button 16 of the neck or wrist pendant device 10.
2. The pendant device 10 processor 12 activates the pendant transceiver 15 to transmit a first signal 41 to the telephone dialing device 20 RF transceiver 22.
3. The telephone dialing device 20 processor 21 upon receipt of the first signal 41 sends a signal for the telephone dialer 25 to dial the monitoring station 30 telephone number and to transmit a second signal 42 to the monitoring station computer 31.
4. After the monitoring station computer 31 identifies the telephone dialing device 20 from the list, the monitoring station 30 operator 32 sends a handshake signal through the digital receiver to the identified telephone dialing device 20 processor 21.
5. The telephone dialing device 20 processor 21 sends a contact ID code to report an emergency event to the monitoring station 30 computer 31.
6. The monitoring station 30 operator 32 sends a kiss-off signal to the telephone dialing device 20 processor 21.
7. The telephone dialing device 20 is on-hook & starts a 5-minute waiting period to auto-answer any incoming phone call from the monitoring station 30 operator 32.
8. The monitoring station 30 operator 32 calls back to the identified telephone dialing device 20 and makes the central monitoring station computer 31 transmit a third signal 43 to the telephone dialing device 20 to remotely control the telephone dialing device 20. The third signal 43 can be the following DTMF commands:
Enter DTMF tone (2) to open TWO-WAY VOICE COMMUNICATION with the user 11 of the pendant device 10 through the telephone dialing device 20.
Enter DTMF tone (1) to TALK to the user 11 of the pendant device 10 ONLY.
Enter DTMF tone (3) to LISTEN-IN to the user 11 of the pendant device 10 ONLY.
   9. After the identified telephone dialing device 20 receives the third signal 43, the telephone dialing device RF transceiver 22 responsively transmits a fourth signal 44 to the pendent device RF transceiver 15.
   10.
   a) If the third signal 43 is the DTMF command (2):

The pendant transceiver 15 upon receipt of the fourth signal 44 from the telephone dialing device 20 establishes a two-way voice communication through the telephone dialing device 20 between the user 11 and the monitoring station operator 32 for the operator 32 to provide needed assistance for the wireless pendant user 11.

b) If the third signal 43 is the DTMF command (1):

The pendant transceiver 15 upon receipt of the fourth signal 44 from the telephone dialing device 20 enables the operator 32 to talk to the user 11 only through the telephone dialing device 20 for the operator 32 to provide needed assistance for the wireless pendant user 11.

c) If the third signal 43 is the DTMF command (3):

The pendant transceiver 15 upon receipt of the fourth signal 44 from the telephone dialing device 20 enables the operator 32 to listen-in to the user 11 only through the telephone dialing device 20 for the operator 32 to provide needed assistance for the wireless pendant user 11.

What is claimed is:

1. A wireless remote intercom emergency assistance system used in a facility, said system utilizes a wireless pendant transceiver device designed to communicate with a telephone dialing device located within proximity of said facility, said telephone dialing device is designed to signal a monitoring station for an operator to call back and/or place a command to establish two-way voice communication through said telephone dialing device with said wireless pendent transceiver device, which comprises;
a pendant device having,
a battery to supply power to said pendant device electronic circuitry,
a processor to control the operation of said pendant device circuitry,
a microphone and a speaker used for audio communication,
a RF transceiver designed to establish RF communication with said telephone dialing device,
a pendent device button used for activating said pendant device transceiver to communicate with said telephone dialer device,
said telephone dialing device having an RF transceiver used to establish RF communication with said RF pendent device, and used for establishing communication link with said monitoring station,
said RF pendent transceiver transmits a first signal in response to manual action performed on said wireless pendant button by said user, said telephone dialing device upon receipt of said first transmitted signal, transmits a second signal to said monitoring station containing information of said telephone dialing device,
said monitoring station having a computer, said computer containing a list of telephone dialing devices information, said monitoring computer is disposed to receive said telephone dialing device generated second signal to identify said telephone dialing device from said list, and to transmit a third signal to said identified telephone dialing device, said identified telephone dialing device upon receipt of said third signal, said telephone dialing device responsively transmits a fourth signal to said remote pendent transceiver device, said pendent transceiver upon receipt of said fourth signal from said telephone dialing device establishes a two-way voice communication through said telephone dialing device between said user and monitoring station personnel, said monitoring station personnel based on said communication provides needed assistance to said wireless pendent user.

2. A wireless remote intercom emergency assistance system as claimed in claim 1 wherein said pendent device processor contains a supervisory RF signal strength measurement circuitry designed to measure RF communication signal strength between said pendent device and said telephone dialer device, wherein said pendent device in response to RF supervisory signal loss generates audio, visual, and/or vibrating alarm signal to alert said user being out of RF communication proximity of said telephone dialer device.

3. A wireless remote intercom emergency assistance system as claimed in claim 1 wherein said pendent device processor contains a supervisory low battery detection circuitry, said pendent device processor in response to detecting low battery condition generates audio, visual and/or vibration alarm signal to alert said user of low battery condition, and/or transmits said low battery condition detection signal through said telephone dialing device to said monitoring station.

4. A wireless remote intercom emergency assistance system as claimed in claim 1 wherein said telephone dialing device processor contains a supervisory RF signal strength measurement circuitry designed to measure RF communication signal strength between said pendent device and said telephone dialer device, wherein said telephone dialing device in response to detected RF supervisory signal loss generates audio, visual, and/or vibrating alarm signal to alert said user being out of RF communication proximity of said telephone dialer device.

5. A wireless remote intercom emergency assistance system as claimed in claim 1 wherein said telephone dialing device processor contains a supervisory RF signal strength measurement circuitry designed to measure RF communication signal strength between said pendent device and said telephone dialer device, wherein said telephone dialing device in response to detecting RF supervisory signal loss, sends a signal to said monitoring station indicative to said person to be monitored being out of RF communication proximity from said telephone dialing device.

6. A wireless remote intercom emergency assistance system as claimed in claim 1 wherein said monitoring station operator upon receipt of said second signal from said telephone dialing device, said monitoring station operator sends a third (kiss-off) signal to said dialer device to set dialer device on-hook for a predetermined period to auto-answer any incoming phone call from said monitoring station operator, and said monitoring station operator sends a signal to said telephone dialer device to remotely control said dialer device by DTMF commands.
